(19) United States
(12) Patent Application Publication
(10) Pub. No.: US 2006/0010005 A1
(43) Pub. Date: Jan. 12, 2006

(54) Building construction management system

(76) Inventor: William Rowland, Palm Bay, FL (US)

Correspondence Address: Starkweather & Associates, Suite 200, 9035 South 1300 East, Sandy, UT, 84094, US

(21) Appl. No.: 11/178,068

(22) Filed: Jul. 7, 2005

Related U.S. Application Data
(60) Provisional application No. 60/586,323, filed on Jul. 8, 2004.

(51) Int. Cl. G06G 1/12

(52) U.S. Cl. 705/1

(57) ABSTRACT

There is a system of managing building construction including a set of modules including a land module, a money module, a product module, a worker module, a buyer module, and an integration module configured to integrate information and services from the set of modules. There is a method of managing building construction, including providing a database, populating the database with linked information relating to each of a parcel of land, a lender of money, a supplier of product, a supplier of a worker, and a buyer, and enabling the buyer, through the database, to interface with each of the lender of money, the supplier of product, the supplier of the worker, and a government agency governing the parcel of land.

This invention claims priority, under 35 U.S.C. § 120, to the U.S. Provisional Patent Application No. 60/586,323 to William Rowland filed on Jul. 8, 2004, which is incorporated by reference herein.

### BACKGROUND OF THE INVENTION

1. Field of the Invention

The present invention relates to building construction management, specifically to a building construction management system.

2. Description of the Related Art

In the construction of a building, for example a residential home, there are a great number and variety of tasks to be completed. The tasks may be grouped into categories relating to features and/or players that may be important in a construction project. Such categories may include Land, Money, Product, Workers, and Buyers. It may be that all tasks relating to construction of a new building may be categorized under the above five listed categories.

Currently, building construction is a very complicated process and is performed in a near infinite variety of ways. There is little centralization, as each of the players responsible for various tasks are not integrated. Therefore, coordination, communication, and responsibility between various performers are lacking.

Further, there is variety in the methods for carrying out the various tasks. For example, there are near infinite modes of attracting buyers and convincing buyers to purchase a home. In another example, there are near infinite modes for securing compliance with local building codes. Therefore, it is difficult to coordinate efforts and/or information. It is also difficult to predict results and/or parameters with any certainty as different builders, title companies, lenders, building code inspectors, etc. interact very differently.

Some effort has been made to systemize some aspects of building construction. In particular, there have been great strides in modular and/or prefabricated homes. In some examples, up to 80% of a home may be pre-constructed according to defined parameters, thereby centralizing some of the process and standardizing some of the procedures and products.

Further, some effort has been made in creating databases for the various aspects of building construction. However, the databases are configured to satisfy the needs of a particular task or set of tasks, and not to be used outside of the scope of the task or tasks. Therefore, while performance of a particular task may be enhanced, the infrastructure needed to construct a building remains disjointed and chaotic.

What is needed is a building construction management system that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available building construction management systems. Accordingly, the present invention has been developed to provide a building construction management system.

There is a system of managing building construction including a set of modules including one or more of a land module, a money module, a product module, a worker module, a buyer module, and an integration module configured to integrate information and services from the set of modules.

In one embodiment the worker module comprises rating a worker after completion of a job. There may be a website configured to access information in the set of modules. The website may include a 3-dimensional configurable virtual home. In one embodiment, the 3-dimensional configurable model home may be saved as an order and information therefrom may be supplied to the set of modules.

In another embodiment, the products module includes a historical database configured to hold historical product information for statistical analysis thereof. Statistical analysis may include predicting a future price of a product. In one embodiment, the products module includes an electronic contract for services at a real-time updated price upon a final selection of a product.

There is a method of managing building construction, including providing a database, populating the database with linked information relating to one or more of a parcel of land, a lender of money, a supplier of product, a supplier of a worker, and a buyer, and enabling the buyer, through the database, to interface with one or more of the lender of money, the supplier of product, the supplier of the worker, and a government agency governing the parcel of land.

Reference throughout this specification to features, advantages, or similar language does not imply that all of the features and advantages that may be realized with the present invention should be or are in any single embodiment of an embodiment. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of an embodiment may be combined in any suitable manner in one or more embodiments. One skilled in the relevant art will recognize that an embodiment can be practiced without one or more of the specific features or advantages of a particular embodiment. In other instances, additional features and advantages may be recognized in certain embodiments that may not be present in all embodiments of an embodiment.

These features and advantages of the present invention will become more fully apparent from the following description and appended claims, or may be learned by the practice of an embodiment as set forth hereinafter.

### BRIEF DESCRIPTION OF THE DRAWINGS

In order for the advantages of an embodiment to be readily understood, a more particular description of an embodiment briefly described above will be rendered by reference to specific embodiments that are illustrated in the appended drawings. Understanding that these drawings depict only typical embodiments of an embodiment and are not therefore to be considered to be limiting of its scope, an embodiment will be described and explained with additional specificity and detail through the use of the accompanying drawings, in which:

FIG. 1 illustrates a task organization chart according to one embodiment of an embodiment;

FIG. 2 illustrates a business organization chart according to one embodiment of an embodiment; and

FIG. 3 illustrates a profit center organization chart according to one embodiment of an embodiment.

### DETAILED DESCRIPTION OF THE INVENTION

For the purposes of promoting an understanding of the principles of an embodiment, reference will now be made to the exemplary embodiments illustrated in the drawings, and specific language will be used to describe the same. It will nevertheless be understood that no limitation of the scope of an embodiment is thereby intended. Any alterations and further modifications of the inventive features illustrated herein, and any additional applications of the principles of an embodiment as illustrated herein, which would occur to one skilled in the relevant art and having possession of this disclosure, are to be considered within the scope of an embodiment.

Reference throughout this specification to “one embodiment,” “an embodiment,” or similar language means that a particular feature, structure, or characteristic described in connection with the embodiment is included in at least one embodiment of the present invention. Thus, appearances of the phrases “one embodiment,” “an embodiment,” and similar language throughout this specification may, but do not necessarily, all refer to the same embodiment, different embodiments, or component parts of the same or different illustrated invention. Additionally, reference to the wording “an embodiment,” or the like, for two or more features, elements, etc. does not mean that the features are related, dissimilar, the same, etc. The use of the term “an embodiment,” or similar wording, is merely a convenient phrase to indicate optional features, which may or may not be part of an embodiment as claimed.

Each statement of an embodiment is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The independent embodiments are considered to be able to be combined in whole or in part one with another as the claims and/or art may direct, either directly or indirectly, implicitly or explicitly.

Finally, the fact that the wording “an embodiment,” or the like, does not appear at the beginning of every sentence in the specification, such as is the practice of some practitioners, is merely a convenience for the reader's clarity. However, it is the intention of this application to incorporate by reference the phrasing “an embodiment,” and the like, at the beginning of every sentence herein where logically possible and appropriate.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

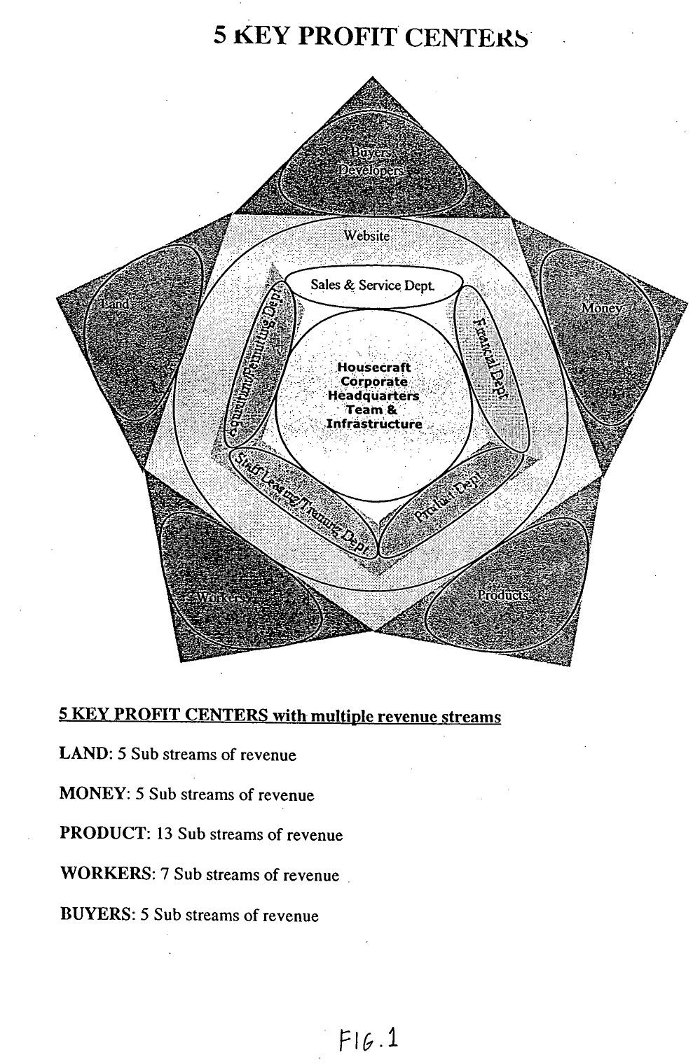

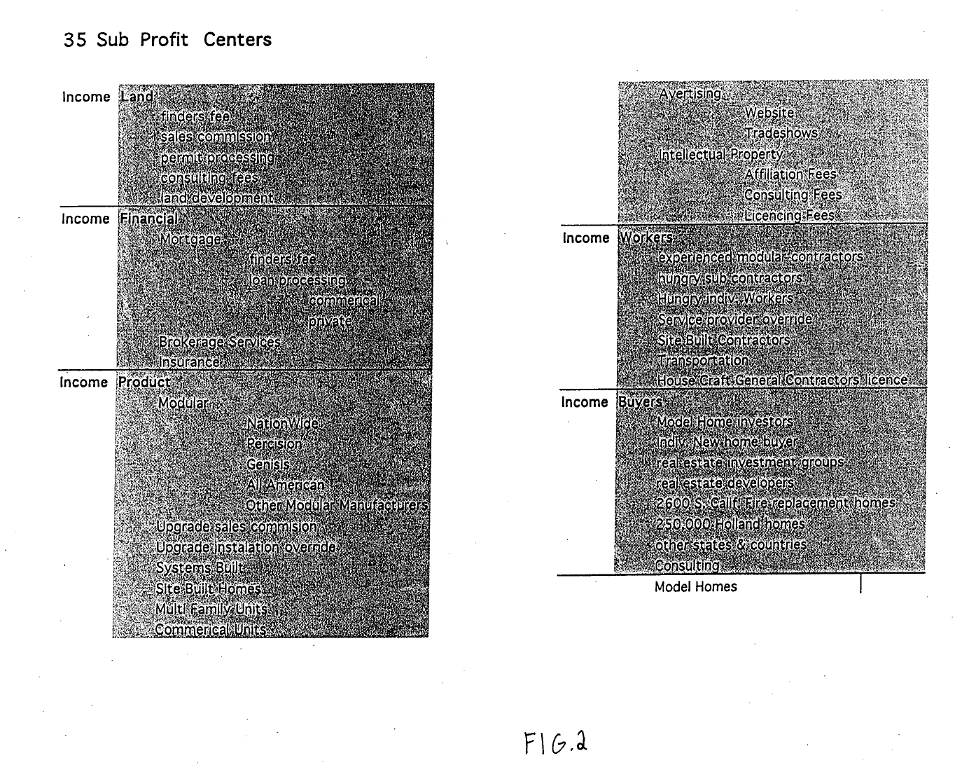

Looking to FIGS. 1-3, there is described a building construction management system. The star in FIG. 1, describes five included departments, or five included profit centers. There is illustrated a Sales and Service Department, or buyers or sales module. There is illustrated a Financial Department, or a money or financial module. There is illustrated a Product Department, or product module. There is illustrated a Staff Leasing/Training Department, or workers module. There is illustrated an Acquisition and Permitting Department, or land module. There is illustrated a Housecraft Corporate Headquarters Team and Infrastructure, corporate headquarters team and infrastructure, or integration module that may be integrating, managing, directing, controlling, and/or facilitating one or more of the other modules. There is illustrated a website that may be utilized by one or more of the modules and that may provide access to one or more of the modules.

Typically, to do any construction project, it takes five included players/performers/departments/companies for any project, those are players/performers/departments/companies corresponding with the land, the money, the product, the workers, and the buyers. There is shown in the center of the illustrated star, the corporate headquarters team and infrastructure configured to orchestrate each of those five included ingredients through paperwork and the project itself to bring each construction project to a completion. Corporate headquarters deals with each of the five included ingredients, primarily through a website. There may be five divisions within the corporation, which focus primarily on each of the five included ingredients.

The five departments may include the Sales and Service Department, which deals with the buyers and real estate developers in coordinating. The Sales and Service Department is preferably very customer-service oriented. There is shown a financial department that will deal with mortgages. The financial department may also deal with investors in larger projects coordinating all or a substantial portion of the financial aspects.

There is shown a product department. Product may include modular homes and/or portions or members thereof. Product may include one or more upgrades included with a home, such as but not limited to interior decorations and/or any options or accessories that might go with a home. So a Product department may be dealing with one or more companies that may produce Product.

There is shown a staff leasing and training department that may reach out through the website to bring in workers. A staff leasing and training department may connect workers, for example as a staff leasing, to contractors requiring workers. There may be worker training, certification of the workers, and/or a reporting of their history, much like an auction site, such as that produced under the trade name of EBay, does for each transaction. In one example, a user of an embodiment, such as a buyer, contractor, etc. may leave positive and/or negative information. In such an embodiment, it is envisioned that quality workers may be identified.

Related to the category of Land, there is shown an Acquisition and Permitting Department. Such a department may find land and may oversee all or a substantial portion of tasks related to local improvements and/or paperwork.

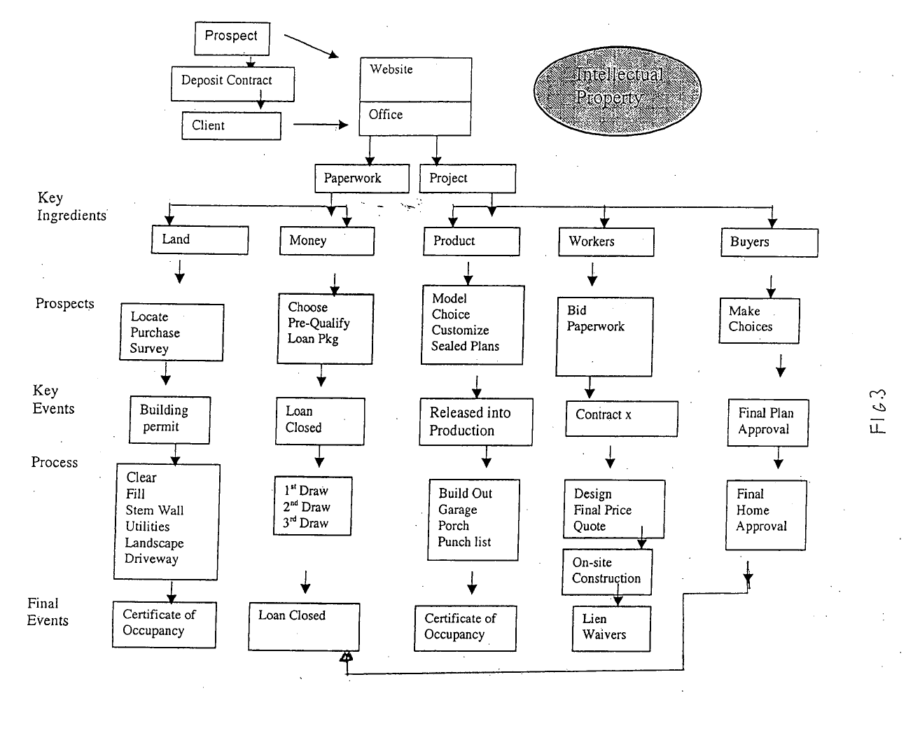

Accordingly, a corporate headquarters may reach out through a website and deal with one or more buyers, and may bring in everything a buyer may need including possibly processing all required paperwork. An example of this from a buyers perspective is shown in FIG. 3.

In one embodiment, the corporate headquarters and the infrastructure that includes the website is kind of the foundation and those five departments sit on top of that foundation, and all interact with each other and corporate in part through the technology of the web. A client may come in through the sales department and it will be the sales department's job to coordinate with the other four departments to ensure that the client's project moves seamlessly from the client's first approaching the embodiment of an embodiment to when the client may move in and sign off on their house.

For sales and services, financial, products, staff, and acquisition, those preferably will need their own core nucleus or modules that would all then integrate to a master module, that shares information, data for reporting, all the tracking, and quality control. There is preferably one integrated system with five core areas that all tie into one central hub that may be the equivalent of the corporate headquarters on the web.

There may be a comprehensive service and certification program for people supplying services. In one embodiment, an embodiment includes a very high level site as far as not only its branding, integrity and quality, but also its functionality and customer satisfaction levels. An embodiment may include building in a plurality of libraries, such as in 30 virtual products, where one can pull up homes, add and remove certain components, extensions, modules, roof types, finishes, materials, on into going truly into the home, placing furniture, on down to possible silverware as far as level of detail where the client may be able to basically pick and choose all their objects. It may be that choices may be tied to an interactive relational database so every object a client may place in their virtual home is saved as their virtual home. The customer may then at anytime modify until the virtual home may effectively lock in a set of choices as a final decision. There may be a transfer of information to a headquarters and to one or more of the additional departments. Therefore a department may be enabled to evaluate and/or extract portions of the information according to functions performed by the department. Also information may be used to help launch, manage, and quality control of the delivery of the project.

There may be an interface or a graphical user interface (GUI) for a consumer that may display an amount of money, such as an amount already spent and how much is left, that may be based on an amount a lender has approved. Accordingly, every time a consumer orders a couch, or upgrades the floors or the countertops, they can see the price, the percentage of the whole price, and/or how much money they've spent. For example, a GUI may display to a consumer that a potential option may be 2% of a whole expenditure. In another embodiment, a GUI may simply add it up as choices are made.

There may be a real time price update. Every time there is a change to something due to the database relationship, the price may be updated and a product department may be working with the actual manufacturers or suppliers to make sure that the embodiment displays current prices. There may be an automatic price update that may allow a consumer to shop 24 hours a day based on real-time prices. An embodiment may coordinate after a consumer has picked a particular product, for example, in lining up when the workers are going to be there, and what worker is designated to do which type of work. For example, whether a particular worker is a wood floor layer or linoleum layer. An embodiment may send out one or more bid requests to one or more different companies and bring back bids on those prices, bids and availability. A history of bids and availabilities may be tracked and/or analyzed. In one example, an embodiment may keep information in a database on average prices for a particular time of year. Accordingly, an embodiment may be able to offer information relating to whether any particular bid is a high or low bid. There may be information relating to prices in different areas. There may be enabled price sharing, wherein an embodiment may know what's an average rate or material price; where plywood was expensive, and where across the state it was cheap.

In one embodiment, the embodiment may be on a scale such that a substantial number/percentage of other companies may participate. Accordingly, a lending company plays in and actually feeds their information into a system. A material provider may be responsible for keeping the system current with their information. A company may be given administration tools where they can manage, for example a lumber company that may be a preferred provider. There may be a contract that requires a company to keep their numbers updated in the system so it is accurate to whatever degree required by the contract.

In one embodiment, there is an ability to submit for a bid and wait for responses. There may also be an ability to force competitive positioning on real-time pricing.

There may be houses that are pre-drawn up. An architect may submit drawings that may be already put together or designed and the buyers may be enabled to go look at them on line. Therefore, if a buyer picks that particular architects work, then there's a commission paid to that architect for selecting his plan on the web site. Accordingly, there may be a library of architects from all over the nation to select from on the web site.

There is a lighter and/or simpler embodiment including dealing in modular construction, wherein requirements are much stricter to stay within specific models. An embodiment may be capable of allowing a design of homes that would work modular that can then be made by the different manufacturers to proprietary specifications.

Additionally, an embodiment may deal with panelized and customizing the modules in new ways. Panelized is defined as walls that come in sections; for example, there may be 8×16 foot panels that are then put together on site. One still must do all the interior walls, and the drywall and the plumbing and electric. With modular all that is done in the factory.

There may be an embodiment including a 3D visual concept. There may be an ability to look at 3D virtual floor and architect plans. There may be 3D visualization of a building or option, so people can see what they're buying. Thus, an embodiment may work for site built homes. In one embodiment the 3D visualization may be in any real estate office, permitting professionals to sell homes in a much better 3D virtual reality that is not out there right now.

In one embodiment, an architect may be able to come in with his own new home, put it on the web site for the buyers to look at and if that architect's home is used he would get some kind of architect compensation. The new home may be going through a whole, standardization process or modular process which an embodiment may then put in the products, the workers, the land, the money, etc. Acceptance of new home designs may fit under the worker category. Examples of workers include: architects, contractors, subcontractors.

In one embodiment, there may be new types of modular systems, thereby permitting an embodiment to offer new design. Preferably, each new design would go through a process of getting it completely modularized.

One of the included aspects that an embodiment handles offers virtually every other contractor out there in the world is managing their project in a much more efficient way. There may be an embodiment wherein an individual home or development may be sculpted out into a project chart development, such as a Gant chart, so that a builder a developer or a homeowner, or a supplier, on any given day, may be permitted to see how far along a project is and what's going on. In one embodiment, a system may be available for any contractor, any builder, any developer, so that they too can offer this system of the “star” to take their clients to, or their customers through the process of knowing exactly how progress on the home is at any given time or day.

In another embodiment, there are cameras on site so that the builders or the homeowners or whomever, can see the progress being made. They may be able to critique progress and send direction relating to a project. For example, a user may be enabled to stop work to have something redone. A user may be enabled to control the pointing of the camera, so he can track it, or move it or look at different parts. Thus an embodiment may have offsite real time supervision from many different locations and people.

In one embodiment, there may be included a feature wherein a homebuyer may have access to information on a website. Thus as the interest rates may change, as the lumberyard increases their pricing or decreases it, you can see real time of what the cost of the house is. As one painter drops off and another painter comes in, with his rates plugged in an embodiment can see all of those factors brought in and an embodiment can lock in at all of those things sort of instantaneously as the house is being envisioned in 3D in the modular sense. Also, as the interest rates go up, as the property taxes change, as the price of wood changes, or paint, or whatever real time pricing can be given on the web site to those of interest. And as the client makes changes to the order so that the general contractor can go online at the jobsite to see if the change order he's hearing about has been approved either by the city or the bank or with whoever else is involved.

An embodiment may be directed to those who are building hundreds of homes instead of one home. In one example, a developer is going to build 100 homes that are going to take 3 months to build, and the pricing of wood, lumber, interest rates are all guaranteed. In one embodiment, a system can bring in homes from multiple factories, and a developer can see how it's changing the price for the exact same house from week to week and day to day, and then the developer knows proper pricing when selling a particular home. There may be an embodiment wherein a website is designed to attract buyers to buy those homes and handle all the paperwork.

In another embodiment, there is statistical tracking. For example, it may be shown that a certain house was worth, last week, $100,000, now this house is worth $102,000 just because of the price of the interest rates going up, or wood and materials. All of this may be put into a graph. There may be a graph showing the development project, i.e. the first homes were this price, the middle homes were this price, the embodiment expects the end homes to be this based on this graph. That may be an incentive for people to be buying now instead of later. There may be an embodiment that ties into the community.

In one embodiment, a database and collection of information is configured to help builders identify what consumers want in real time, what it is the changing market wants. What it is that they're really asking for, like ranch homes, split level, bay windows, larger master bathrooms, colors, woods, tiles, etc. The statistics may help the builder make the homes that most of the people want. It may also allow contractors to have depth of knowledge of the consumers interests so that a contractor of this network may be able to spend a day looking at their competition analyzing what their homes are selling for, square footage, what colors they are using, and their advertising, and as the market changes, an embodiment allows people in real time to see just exactly what it is that home purchasers want. If they are looking at a tan house, and now their looking at a white house, and now their shifting to blue.

In another embodiment, there is provided the ability to fix a cost of the building. For example, if an embodiment has relationships with lumber suppliers since the prices of everything change every week, there would be an opportunity to fix the price of the building at one particular point in time, by having an online two way agreement with a vendor that provides a material in a particular location, say Central Florida.

For example, one may have purchased nails, even though they haven't been delivered yet, they may not be delivered for three months, but an embodiment have a deal with a major supplier that they're going to deliver those nails in three months at the exact price that an embodiment just fixed. Advantageously, an embodiment may acquire so much data, that an embodiment may be able to make predictions.

In one example, there is a developer in California. The developer look at a products actual historical numbers of users (buyers, sellers, financing, workers etc.), the system will then project that out like a stock market projector will, preferably more accurately, and tell us what's likely to happen three months from now at the rate we're going if things don't change in the economy, etc. Based on that, the developer may make some very major decisions that will help hedge bets as far as making decisions for business in the future.

One solution provided in an embodiment is that wherein modular construction is advanced, the software is not up to par. They have perfected building multiple homes in modules really well. They have their hardware there, they don't have the software. They have not come up with a way to effectively market and portray those homes, and organize the construction of those homes, and attract the people they want to attract. So a system may include the software to propel the innovation of modular construction.

In one embodiment, one or more prospects (for example, home purchasers) go on a website, and look at whether they're looking to buy a home, or build a subdivision, or get a job, or sell a product, or get involved financially. A prospect may go through the website and become involved. A buyer may become involved when they give a deposit; contractors, builders may become involved contractually, and then they come into a central network. Accordingly, as they go into a project, this is what they're looking for, a project, so they can get what they want. Typically a project is driven by labor and paperwork.

Looking to FIG. 3, an embodiment may come down a deal with the land. There may be 5 included ingredients, those rows of blocks across the top. Then an embodiment may have prospects. They come in as prospects, somebody with land, land needs to be located, purchased, if somebody owns land they need to say I own land and here it is. This is pretty much set up for buyers. This flowchart is set up for buyers. So a buyer or developer needs land, it needs to be located, it needs to be purchased, it needs to be surveyed. Now a step that may happen, an included event, is a building permit. Everything is recognized as being ok with the local government. Let's bring each of these 5 included ingredients down to an included event. A buyer comes in, they need to choose a lender, they need to be pre-qualified, and they need their loan package, all that paperwork involved. An included event for money is the loan is closed. This is the construction part of the loan to build the home or the subdivision.

The product, step that they may need to do is choose the model, one of the 100's models we've got then customize it as it pertains to them. Putting in windows or doors or upgrading sinks, whatever they want to do. They make their final choices, and an embodiment get sealed plans. They come back sealed plans, already approved for the local government and are required for the building permit. An included step of the product may be that the home is released into production to be built. Before that can happen, there should be a building permit and the loan should be closed.

An included ingredient may be the workers. There may be office workers, sales teams, construction workers, presentation teams that would be doing trade shows and such. Workers come in an embodiment enter into a contractual agreement with them, and that is an included event.

In one embodiment, a buyer may enter a system. They may have already gone from a prospect to a client; they make all their final choices, and they sign off on the final approval of their plans. Now everything is in place now to actually build the house. An embodiment go back through the process now, we've got the land which involves clearing the land, the fill, building the stem wall, bringing in the utilities, landscaping, the lot or subdivision, all the paperwork, building permits, all of that is included in this is well. That's the process, when the process for the land is finished, the county gives a certificate of occupancy, and the home is ready to move into. An embodiment may go to the next included ingredient; an embodiment go from the construction loan, the construction perm loan, through the different draws to fund the project, when the house is delivered from the factory for all the work that is done to pay the subcontractors. When the money is done, the loan is closed; the loan converts to a 30 year mortgage. Everything is signed off at the bank. They're happy with everything. The product arrives on site. An embodiment does the build out, an embodiment adds a garage or porch or whatever punch list is necessary, the certificate of occupancy seals the project that everything is completed. The workers come in, an embodiment have their contract, an embodiment have their legal paperwork, whether its workers comp. insurance, business license, whatever. An embodiment send out for bids, the database sends out for bids to the people in our database who do each of the projects. An embodiment works out their final price and quote. They do the onsite construction. They're finished with their construction. The last thing that happens is an embodiment gives them lien waivers stating that the work is done and they have been paid in full. The buyer goes from their final plans to basically watching the construction happen and give final approval that everything meets their requirements. And as soon as they do that, then all the other tasks such as obtaining a Certificate of Occupancy, that project is done. And that project has flowed onsite through the project and also through the database website and all the paperwork and legal filing is required.

There may be an embodiment including labor and the price sharing. There may be an embodiment including a 3D aspect with real time pricing. There may be an embodiment including paperwork processing. One of the things an embodiment may be able to do, an office will be so efficient, and an embodiment will be able to process much of the paperwork, not only for a system and/or a network of contractors, but for other contractors as well.

One of the trends in the marketplace is that building permits are getting so confusing that small companies are now starting to form that do nothing but process the paperwork, and stand in the lines, and make sure that everything is there. So an embodiment could do that not only with building permits, but also with mortgages. And an embodiment may process mortgage paperwork within the system. An embodiment may be intended to assist selling the whole home right down to the napkins and silverware.

It is understood that the above-described preferred embodiments are only illustrative of the application of the principles of the present invention. The present invention may be embodied in other specific forms without departing from its spirit or essential characteristics. The described embodiment is to be considered in all respects only as illustrative and not restrictive. The scope of an embodiment is, therefore, indicated by the appended claim rather than by the foregoing description. All changes which come within the meaning and range of equivalency of the claims are to be embraced within their scope.

Thus, while the present invention has been fully described above with particularity and detail in connection with what is presently deemed to be the most practical and preferred embodiment of an embodiment, it will be apparent to those of ordinary skill in the art that numerous modifications, including, but not limited to, variations in size, materials, shape, form, function and manner of operation, assembly and use may be made, without departing from the principles and concepts of an embodiment as set forth in the claims.

What is claimed is:

1. A building construction management system, comprising:
a set of modules including at least three different modules selected from the group of modules consisting of:
a land module;
a money module;
a product module;
a worker module; and
a buyer module; and
an integration module configured to integrate information and services from the set of modules.

2. The building construction management system of claim 1, wherein the set of modules comprises:
a land module;
a money module;
a product module;
a worker module; and
a buyer module.

3. The building construction management system of claim 2, wherein the worker module comprises rating a worker after completion of a job.

4. The building construction management system of claim 1, further comprising a website configured to access information in the set of modules.

5. The building construction management system of claim 4, wherein the website includes a 3-dimensional configurable virtual home.

6. The building construction management system of claim 5, wherein the 3-dimensional configurable model home may be saved as an order and information therefrom may be supplied to the set of modules.

7. The building construction management system of claim 2, wherein the products module comprises a historical database configured to hold historical product information for statistical analysis thereof.

8. The building construction management system of claim 7, wherein statistical analysis comprises predicting a future price of a product.

9. The building construction management system of claim 2, wherein the products module comprises an electronic contract for services at a real-time updated price upon a final selection of a product.

10. A method of managing building construction, comprising:
providing a database;
populating the database with linked information relating to each of a parcel of land, a lender of money, a supplier of product, a supplier of a worker, and a buyer; and
enabling the buyer, through the database, to interface with each of the lender of money, the supplier of product, the supplier of the worker, and a government agency governing the parcel of land.
